(19) United States
(12) Patent Application Publication
(10) Pub. No.: US 2019/0226595 A1
(43) Pub. Date: Jul. 25, 2019

(54) Automatic Gas Shutoff System

(71) Applicant: Matthew T. Mattos, Yuba City, CA (US)

(72) Inventor: Matthew T. Mattos, Yuba City, CA (US)

(21) Appl. No.: 16/252,811

(22) Filed: Jan. 21, 2019

Related U.S. Application Data
(60) Provisional application No. 62/709,520, filed on Jan. 22, 2018.

(51) Int. Cl. F16K 17/36; F27D 19/00; F27D 21/00

(52) U.S. Cl. CPC F16K 17/36; F27D 19/00; F27D 2019/004; F27D 2021/0078; F27D 2019/0015; F27D 21/00

(57) ABSTRACT

An automatic gas shutoff system for protecting the occupants of a home, apartment, RV, vehicle, etc. from dangerous levels of carbon monoxide. The automatic gas shutoff system generally includes one or more carbon monoxide detectors, a control unit, and a gas shutoff valve under the control of the control unit, so that the gas supply to a malfunctioning appliance can be shut off in the event it is creating dangerous levels of carbon monoxide within a protected space. The shutoff valve may have a manual reset feature that requires a problem condition to be repaired before the valve is manually reset to allow normal gas flow to resume.

### CROSS REFERENCE TO RELATED APPLICATIONS

I hereby claim benefit under Title 35, United States Code, Section 119(e) of U.S. provisional patent application Ser. No. 62/709,520 filed Jan. 22, 2018. The 62/709,520 application is currently pending. The 62/709,520 application is hereby incorporated by reference into this application.

### STATEMENT REGARDING FEDERALLY SPONSORED RESEARCH OR DEVELOPMENT

Not applicable to this application.

### BACKGROUND

### Field

Example embodiments in general relate to an automatic gas shutoff system for relates to carbon monoxide safety devices for dwellings and recreational vehicles, and more particularly to a system for automatically terminating natural gas flow to a malfunctioning or non-ignited source that is producing dangerous levels of carbon monoxide.

### Related Art

Any discussion of the related art throughout the specification should in no way be considered as an admission that such related art is widely known or forms part of common general knowledge in the field.

Various gas and leak detection systems have been in use for a number of years, for alerting occupants of an enclosed area to the presence of harmful gases that might otherwise go undetected. Typically, such system and devices are directed to sounding an audible alarm when a harmful, invisible gas is detected.

While such devices may fulfill their particular role, particular objectives and requirements, they do not disclose a system that is capable of automatically stopping the problem at its source—that is, shutting off the supply of gas (such as natural gas) that is provided to a malfunctioning appliance.

In these respects, the automatic gas shutoff system according to the present invention substantially departs from the conventional concepts and designs of the prior art, and in so doing provides an apparatus primarily developed for the purpose of automatically terminating natural gas flow to a malfunctioning appliance which is producing dangerous levels of carbon monoxide, while requiring repair prior to the valve operation being reset.

### SUMMARY

An example embodiment is directed to an automatic gas shutoff system. The automatic gas shutoff system includes a first detector (such as a carbon monoxide or smoke detector) having an output, wherein the output is activated when a detected carbon monoxide level or smoke exceeds a threshold that represents the environmental state of air in a room. The first detector is adapted to transmit an environmental state data based on the environmental state of air in the room.

An example embodiment of the system also comprises gas shutoff valve, wherein the gas shutoff valve is normally open until it receives an electrical current to close the gas shutoff valve. The gas shutoff valve may have an inlet port and an outlet port, wherein the inlet port is fluidly connected to a gas inlet line, wherein the outlet port is fluidly connected to a gas outlet line, wherein the gas inlet line is fluidly connected to a gas source and wherein the gas outlet line is connectable to a gas appliance. The gas shutoff valve has an open state that allows passage of gas and a closed state that prevents passage of gas, wherein the gas shutoff valve is normally in the open state.

Example embodiments of the automatic gas shutoff system may also include a control unit in communication with the first detector to receive the environmental state data from the output of the first detector, wherein the control unit is in communication with the gas shutoff valve to control whether the gas shutoff valve is in the open state or closed state, wherein the control unit transmits a close signal to cause the gas shutoff valve to change from the open state to the closed state when the environmental state of the air in the room is determined to be in an unsafe state.

In an example embodiment, the unsafe environmental condition may be a level of carbon monoxide above a safe threshold, which may be a time-weighted threshold. In one aspect, the time-weighted threshold is no greater than 10 hours at a carbon monoxide level of 40 PPM—meaning that the carbon monoxide detector will activate in 10 hours or less when the detected carbon monoxide level is 40 PPM. Typically, as carbon monoxide levels increase, the carbon monoxide detector will active in a shorter period of time. For example, the time-weighted threshold may be no greater than 50 minutes at a carbon monoxide level of 150 PPM, and no greater than 15 minutes at a carbon monoxide level of 400 PPM.

In another example embodiment, the gas shutoff valve of the automatic gas shutoff system comprises a manual reset. In another example embodiment, the gas shutoff valve remains closed without any electrical current until it is manually reset. In some embodiments, the electrical output of the control unit is activated for a fixed time, for example, for an amount of time necessary to activate the gas shutoff valve, which will nevertheless remain closed in some example embodiments after current is removed. In still other embodiments, the electrical output of the control unit is latched on once it is activated.

In an example embodiment, the control unit comprises an audible alarm that sounds when the output of the first carbon monoxide detector is activated.

In still another example embodiment, the automatic gas shutoff system may further comprise a second carbon monoxide detector having an output, wherein the output is activated when a detected carbon monoxide level exceeds a time-weighted threshold, representing an unsafe environmental state. In this example embodiment, the control unit is further coupled to the output of the second carbon monoxide detector, the control unit sending an electrical output to close the gas shutoff valve when the output of the first or the second carbon monoxide detector is activated.

The control unit may, in some embodiments, also comprise a test function, the control unit sending an electrical output to close the gas shutoff valve when the test function is activated. The control unit may also comprise an audible alarm that sounds when the output of the first carbon monoxide detector or the second carbon monoxide detector is activated.

The control unit of example automatic gas shutoff systems may further comprise an interface to a remote alarm company, wherein the control unit sends an alarm signal to the alarm company when the output of the first carbon monoxide detector or the second carbon monoxide detector is activated.

There has thus been outlined, rather broadly, some of the embodiments of the automatic gas shutoff system in order that the detailed description thereof may be better understood, and in order that the present contribution to the art may be better appreciated. There are additional embodiments of the automatic gas shutoff system that will be described hereinafter and that will form the subject matter of the claims appended hereto. In this respect, before explaining at least one embodiment of the automatic gas shutoff system in detail, it is to be understood that the automatic gas shutoff system is not limited in its application to the details of construction or to the arrangements of the components set forth in the following description or illustrated in the drawings. The automatic gas shutoff system is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein.

FIG. 1 is a block diagram of an automatic gas shutoff system in accordance with an example embodiment.

FIG. 2 is another block diagram of an automatic gas shutoff system in accordance with an example embodiment.

FIG. 3 is a side view of an RV and components of the automatic gas shutoff system in accordance with an example embodiment.

FIG. 4 is a front view of a mounting configuration for components of an automatic gas shutoff system in accordance with an example embodiment.

FIG. 5 is a side view of an installation of an automatic gas shutoff system in accordance with an example embodiment.

FIG. 6A is an overall diagram of an installation of an automatic gas shutoff system in accordance with an example embodiment.

FIG. 6B shows detail of a ventilation fan in accordance with an example embodiment.

FIG. 7 is another front view of a mounting configuration for components of an automatic gas shutoff system in accordance with an example embodiment.

FIG. 8 is a perspective view of a gas shutoff valve of an automatic gas shutoff system in accordance with an example embodiment.

FIG. 9 is a flow chart illustrating steps usable by the automatic gas shutoff system in accordance with an example embodiment.

### DETAILED DESCRIPTION

### A. Overview.

An example automatic gas shutoff system is useful for protecting an enclosed environment, such as the interior space of a house, RV, boat, vehicle, etc., from dangerous levels of carbon monoxide or smoke that may be harmful to the occupants.

Such an example system generally comprises one or more carbon monoxide detectors 30, each having an output, wherein the output is activated when a detected carbon monoxide level exceeds a threshold. As an example, the threshold may be a time-weighted threshold, and more specifically, such a threshold may be no greater than 10 hours at a carbon monoxide level of 40 PPM—meaning that the carbon monoxide detector will activate in 10 hours or less when the detected carbon monoxide level is 40 PPM. Typically, as carbon monoxide levels increase, the carbon monoxide detector 30 will active in a shorter period of time. As noted above, the time-weighted threshold may include additional breakpoints as follows: no greater than 50 minutes at a carbon monoxide level of 150 PPM, and no greater than 15 minutes at a carbon monoxide level of 400 PPM.

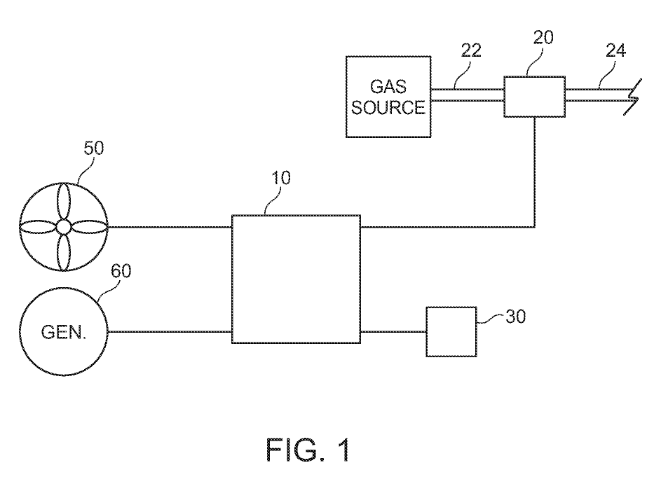

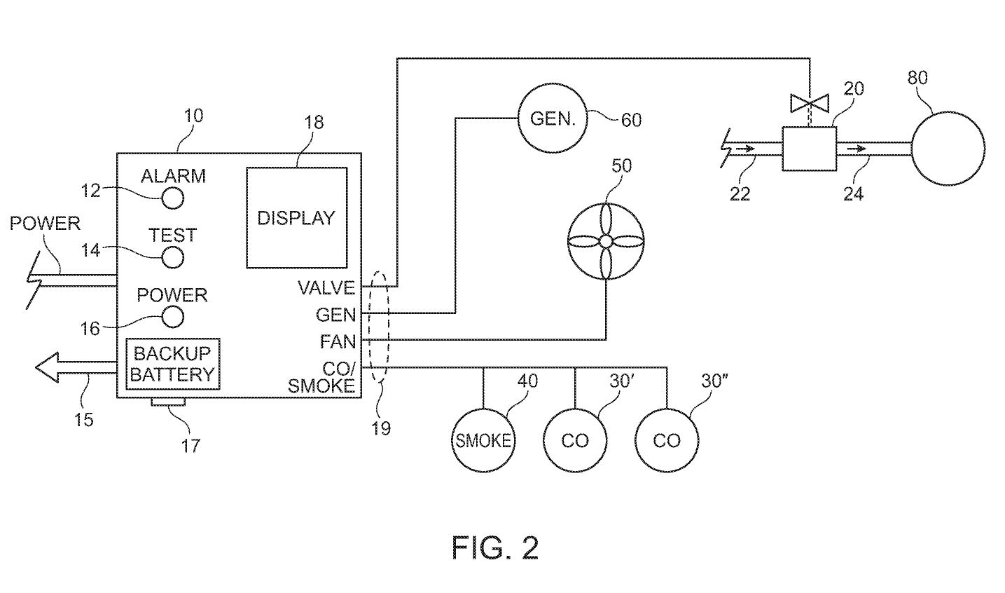

FIG. 1 illustrates the basic components of the system, while FIG. 2 shows the system in somewhat more detail. Further, the example embodiment of FIG. 2 illustrates the system using a particular type of gas shutoff valve 20, specifically, a solenoid-operated valve, while other types of valves are also usable with the system.

The system may also include a gas shutoff valve 20, which may be a normally open type, until the valve 20 receives an electrical current commanding it to close. The system may also include a control unit 10 coupled to receive signals from the output of the carbon monoxide detectors 30. The control unit 10 is also coupled to the gas shutoff valve 20. When required, the control unit 10 sends an electrical output, such as an electrical current, to close the gas shutoff valve 20 when the output of any carbon monoxide detector 30 is activated—in other words, where a dangerous or potentially dangerous level of carbon monoxide is present.

The gas shutoff valve 20 may be of the type that requires a manual reset. For example, the gas shutoff valve 20 may be normally open, such that gas flows without requiring any activation or signal to the valve 20. Upon activation, as described briefly above, the valve 20 receives current and closes, but even after current is removed, the valve 20 may stay closed until it is manually reset, for example, by physically operating a plunger or mechanism. Thus, the valve 20 has an open state and a closed state, where to open state allows gas to flow from a gas inlet line 22 to a gas outlet line 24, and the closed state cuts off that flow.

The control unit 10 may also have a test function, wherein the control unit 10 sends an electrical output to close the gas shutoff valve 20 when the test function is activated. The control unit 10 may also comprise an audible alarm that sounds when the output of one or more of the carbon monoxide detectors 30 are activated.

The control unit 10 of an example automatic gas shutoff system may further comprise an interface to a remote alarm company, wherein the control unit sends an alarm signal to the alarm company when the output of the first carbon monoxide detector or the second carbon monoxide detector is activated.

### B. Control Unit.

As best shown in FIGS. 1 and 2, a control unit 10 is central to the automatic gas shutoff system. The control unit 10 may be powered by typical household voltage, such as 110 VAC, or it may alternatively powered by a battery, which is especially suitable for vehicle or RV applications, where the battery voltage may be 12 VDC. Regardless of the primary power source, the control unit may have a backup battery. As shown in FIG. 2, the backup battery is indicated as being within the control unit 10, but this is simply one possible configuration. For example, the backup battery may be a relatively high-capacity battery that is too large for containment within the control unit 10, in which case it may be externally mounted.

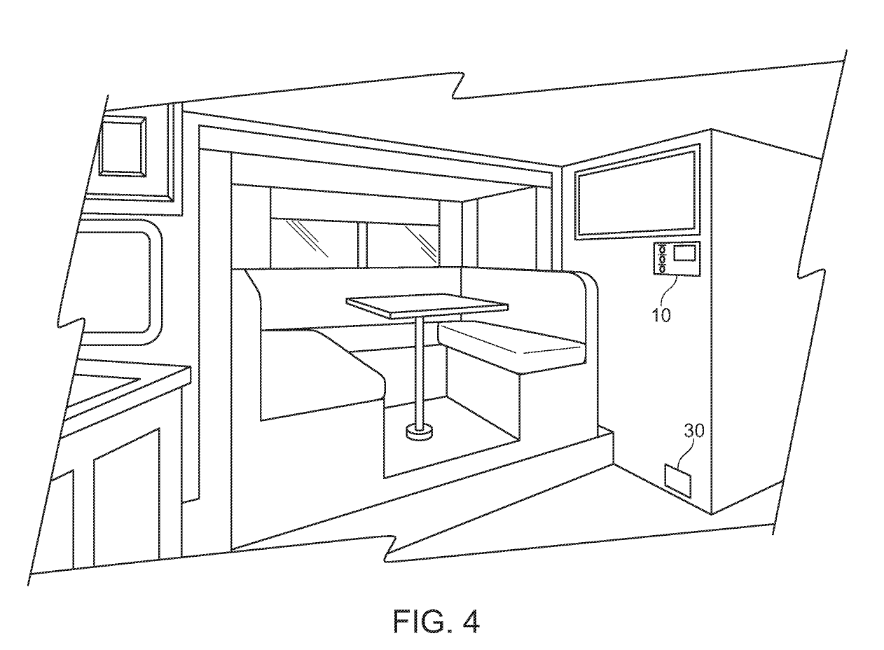

Since the control unit 10 serves as the user interface to the system, it is typically mounted on a wall or control panel in a house or RV, at a convenient height for a user to see and operate, as best shown in FIG. 4. Control unit 10 may include a microprocessor, or it may comprise a analog or digital circuitry, a microcontroller, or any combination of the foregoing. As shown in FIG. 2, the control unit 10 provides a central point of control for the system, and thus accepts various inputs and generates outputs as required for the operation of the system. Various inputs and outputs are made though an input/output interface 19, which may be a common electrical connector, or a wiring terminal, as just two examples.

As is known, wiring terminals may be installed on printed circuit boards, which configuration may be used with the example embodiments, wherein the inputs and outputs show in FIG. 2, for example, comprise wires to the devices shown, such as carbon monoxide detectors 30, smoke detectors 40, a generator or generators 60, a ventilation fan 50, and one or more gas shutoff valves 20. As also shown one or more ventilation fans 50 may be used with the system to provide ventilation to clear an unsafe air condition. The control unit 10 may have contacts and turn on such a fan 50, which may be installed with louvers that open when the fan is on, but otherwise be closed.

In some embodiments, these wires and devices may be installed in a permanent way, such as by incorporating them into the house wiring and infrastructure, either prior to or after the initial construction of a house, RV, or other vehicle, for example.

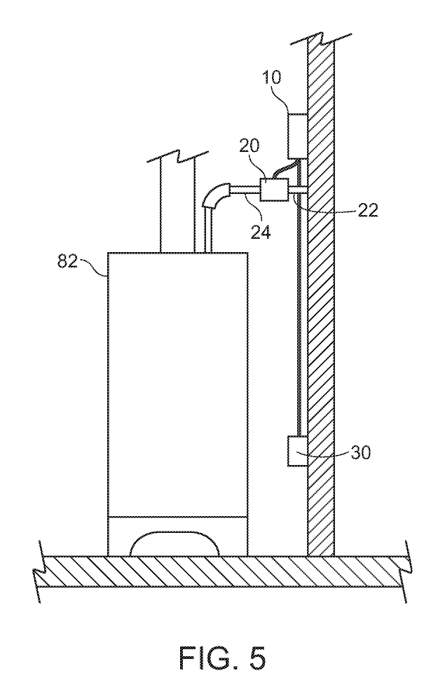

Alternatively, the system may also be installed in a less permanent fashion, such as installation by a homeowner. As an example of this, the system may be powered by a plug-in power supply or converter, or be battery powered, and mounted in a finished, semi-finished, or unfinished area, such as on an exposed stud in a basement, next to a water heater 82 or other gas appliance, as shown in FIG. 5.

It should be appreciated that the location and mounting of the control unit 10, as well as the location and number of associated components of the system, may vary in different embodiments, and thus should not be construed as limited by the exemplary figures. In some embodiments, the control unit 10 may be mounted very close to a single carbon monoxide detector 30 and a gas shutoff valve 20, as shown in FIG. 5. In other embodiments, the system may comprise a network of sensors 30 and 40, located farther away from the control unit 10. In such a configuration, the gas shutoff valve 20 may also be farther away from the control unit and detectors 30 and 40.

The control unit 10 may also include a display 18 to show the operational status of the system, and it may include indicator lights such as an alarm indicator 12 and a power status indicator 16. As mentioned above, the control unit 10 may also have a test function, which can be initiated by a user pressing a test button 14, as well as by other means, such as a timed function or a remote actuation.

The test function of control unit 10 may be used by outside entities, such as insurance companies, to provide confidence that a dwelling or vehicle is protected, which may in turn be used to reduce the premium paid by a user or homeowner. As an example, the control unit 10 may optionally include a USB port 17 or a wired or wireless communications interface, so that data regarding tests and actual alarm events can be recorded and stored electronically in a memory built in to the control unit 10, and then provided to the insurance company. Specifically, a user may insert a USB memory device (not shown) into USB port 17, at which time a data transfer comprising information from tests of the system can be downloaded onto the USB memory device. The memory device (or simply the logged data) may then be sent to the insurance company for verification of testing of the automatic gas shutoff system.

As noted, however, such test or alarm event information may also be transmitted over any other type of communication interface, such as Bluetooth, Wi-Fi, or wired or wireless telephone line. Information regarding testing or system status may also be shared between an alarm monitoring company and an insurance company. For example, test or actual alarm event information may be transmitted over communication interface 15, which may be a telecommunication interface of the type known and used with central alarm systems. In addition to use for insurance purposes, of course the communication interface 15 may be used to automatically contact an alarm monitoring company or fire department for the purpose of alerting emergency personnel and to initiate a call to the occupants of a home to determine whether an actual event, such as a high carbon monoxide or smoke level, has occurred and should be responded to.

As mentioned briefly above, the control unit 10 includes inputs and outputs 19. Among the outputs not previously discussed are an output for activating a ventilation fan 50 and an interlock type of output for allowing a generator 60 to remain activated. For example, the ventilation fan 50 may be activated when a high carbon monoxide or smoke level is detected by any of the detectors 30 or 40. More specifically, if the carbon monoxide level exceeds a time-weighted threshold such that the gas shutoff valve 20 is activated (i.e., closed), the ventilation fan may be activated by an output from the control unit 10. Similarly, and especially applicable to an RV installation of the automatic gas shutoff system, a relay or other output within control unit 10 may be activated. In addition to carbon monoxide level, the system may be activated upon detection of smoke by smoke detector 40, in which case, as with detector 30, the gas shutoff valve 20 can be actuated to stop the flow of gas to a home or vehicle if an unsafe condition is detected.

To provide the outputs shown, the control unit 10 may include a relay or relays with 3 Form-C contacts rated at 120 VAC/10 A that can be used as described here for multiple purposes, such as an exhaust fan interlock, generator interlock, disabling the gas shutoff valve, external audible and visual alarms, and for emergency lighting, for example. In addition, the control unit 10 may also include a built-in audible alarm, which will sound when smoke, gas, or carbon monoxide is detected by any sensor in the system.

If a normally closed relay contact, or its equivalent, is used, the “output” may act as an interlock, allowing an electrical generator 60 to run under normal conditions, but locking out the operation when a high level of carbon monoxide is detected. Accordingly, the gas supply to any malfunctioning device or appliance be cut off. The output of control unit 10 may also be used to remove the power to a generator, for example, in an RV application, by using the contacts as an interlock. Similarly, the use of a ventilation fan 50 will also provide additional safety in the event of a gas leak, by providing ventilation within a living space affected by the leak, or by removing excess carbon monoxide or smoke.

### C. Carbon Monoxide and Smoke Detectors.

As shown in FIG. 2, one or more carbon monoxide detectors may be connected to the control unit 10. In addition to being hardwired, the carbon monoxide detectors 30 or smoke detectors 40 may communicate wirelessly with the control unit 10, for example by radio (including Wi-Fi link) or infrared link. Moreover, the carbon monoxide detectors 30 may be of several types. As one example, each carbon monoxide detector 30″ may be a market-available gas sensor which includes its own logic and sensing circuitry to be place in the environment where escaped gas or carbon monoxide may be present. In addition to detecting carbon monoxide, the detectors may instead detect the presence of natural gas or propane. Although FIG. 2 shows detectors 30′ and 30″, the system may use multiple detectors of the same type or different types as well.

As discussed previously, carbon monoxide sensors 30 typically use a time-weighted technique, wherein the alarm (or in this case the generation of an activation signal) is triggered upon various conditions, such as a lower level of carbon monoxide for a longer period of time, or a higher level for a shorter period of time. In some example embodiments, market-available detectors will have the logic for time-weighted activation built in, and will simply send an activation signal when the threshold is reached, based on any possible combination of carbon monoxide level and the length of time the level is present in the environment.

As an example of the threshold, the time-weighted threshold may be no greater than 10 hours at a carbon monoxide level of 40 PPM—meaning that the carbon monoxide detector 30 will activate in 10 hours or less when the detected carbon monoxide level is 40 PPM. Then, as carbon monoxide levels increase, the carbon monoxide detector 30 will active in a shorter period of time. For example, the time-weighted threshold may be no greater than 50 minutes at a carbon monoxide level of 150 PPM, and no greater than 15 minutes at a carbon monoxide level of 400 PPM.

In addition to detectors that have their own built-in logic for time-weighted triggering (and, e.g., calibration, etc.), the system may also employ carbon monoxide detectors 30′ that comprise simple detectors or sensors with little, or even no, logic. Such detectors 30′ may include, for example, carbon monoxide detectors that simply provide an analog output that is proportional to or a function of the carbon monoxide level present. Further, somewhat more sophisticated detector modules may be used. For example, very compact carbon monoxide detector or sensor modules are available that provide a calibrated and temperature compensated digital output that is representative of the sensed carbon monoxide level.

Of course, more compact sensors as described above, used as carbon monoxide detector 30 in the system, provide additional flexibility in mounting and location. If such sensors are used, however, the logic for providing a time-weighted activation will be included on the control unit 10. In that case, the display or indicator lights on the control unit 10 may provide additional information, in order to indicate the level of carbon monoxide present, for example, as will be discussed in more detail below. Upon detection of unacceptable levels of carbon monoxide, detectors 30 of the example system will send data on the environmental state in a room to the control unit 10, which may comprise an activation signal, or may also comprise and analog or digital signal proportional to, or a function of, the level of carbon monoxide detected in the environment.

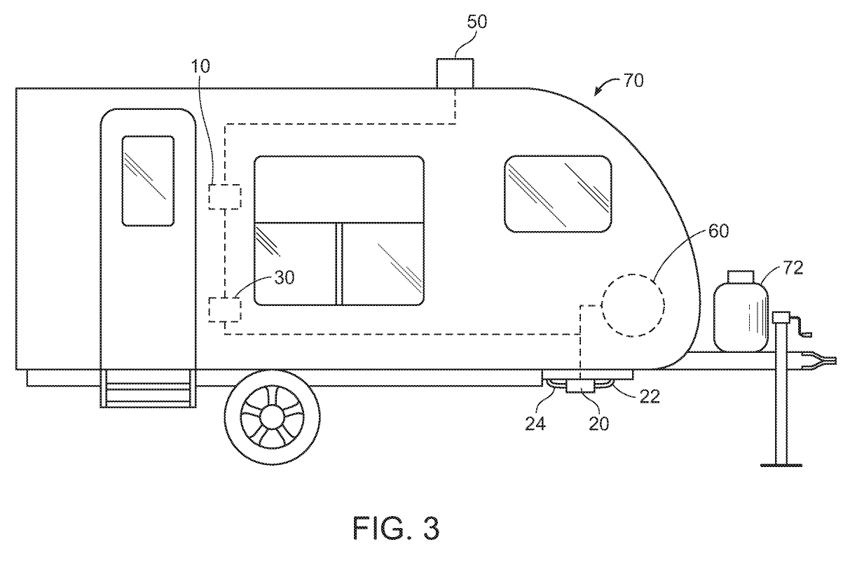

Further, in addition to using carbon monoxide sensing, one or more smoke detectors 40 can be communicatively coupled to control unit 10 (as shown in FIG. 3), so that the control unit 10 initiates gas shutoff valve 20 to stop the flow of gas if an unsafe level of smoke is detected. The control unit 10 may also be coupled to both smoke detectors 40 and carbon monoxide detectors 30′ and 30″, so that the gas shutoff valve 20 can be actuated to cut off gas in the event or an unsafe level of smoke or carbon monoxide. As with the carbon monoxide detector, upon detection of an unacceptable level of smoke, detectors 40 of the example system will send data on the environmental state in a room to the control unit 10, which may comprise an activation signal, or may also comprise and analog or digital signal proportional to, or a function of, the level of smoke detected in the environment.

### D. Gas Shutoff Valve.

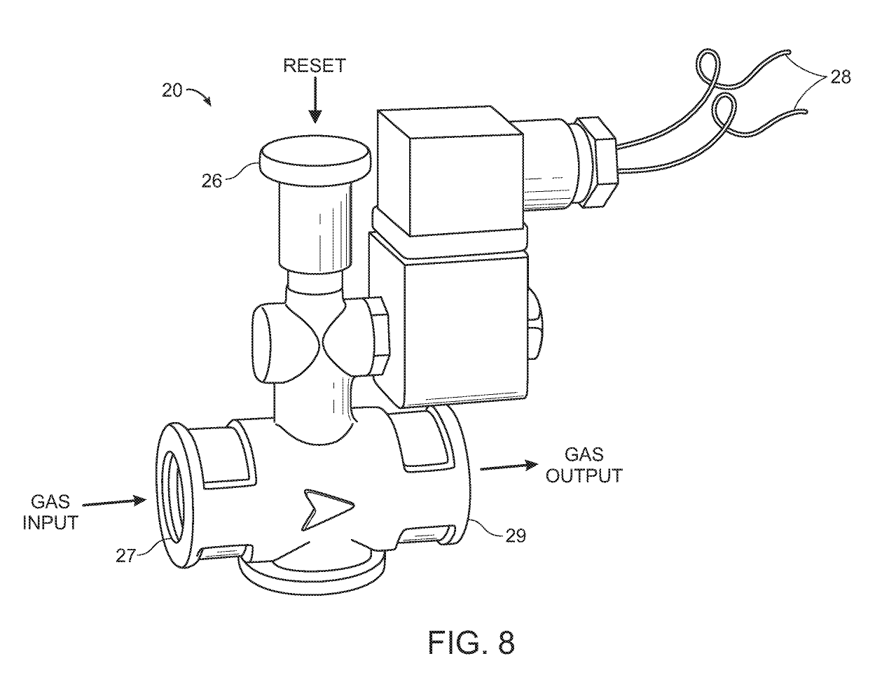

As shown in FIG. 8, a gas shutoff valve 20 may be used with exemplary embodiments of the automatic gas shutoff system. In one possible example embodiment, the gas shutoff valve may be normally open until it receives an electrical current that causes it to close. An example of such a valve is one with a solenoid that operates to close the valve when an AC or DC electrical current is applied to the solenoid leads 28, as shown in FIG. 8. For additional safety, the gas shutoff valve 20 may include a manual plunger 26 that must be pushed or pulled, depending on the specific valve, in order to reopen the valve 20. Such valves are readily available, and operate on relatively small amounts of current, with either AC or DC voltages. Once closed (e.g., upon application of electrical current), as noted above, the valve 20 may remain closed even after current is removed, so that repair of a malfunctioning appliance may be effected before turning the gas supply back on. Alternatively, the output signal provided to the valve may itself be latched, so that current is supplied to the valve 20 until it is reset by the control unit 10. It is of course also possible to use a normally closed valve with the system, so that the presence of a signal is required for the valve to be open. In such an embodiment, the valve 20 will remain closed until it is reset by specific action, such as by manually operating a plunger.

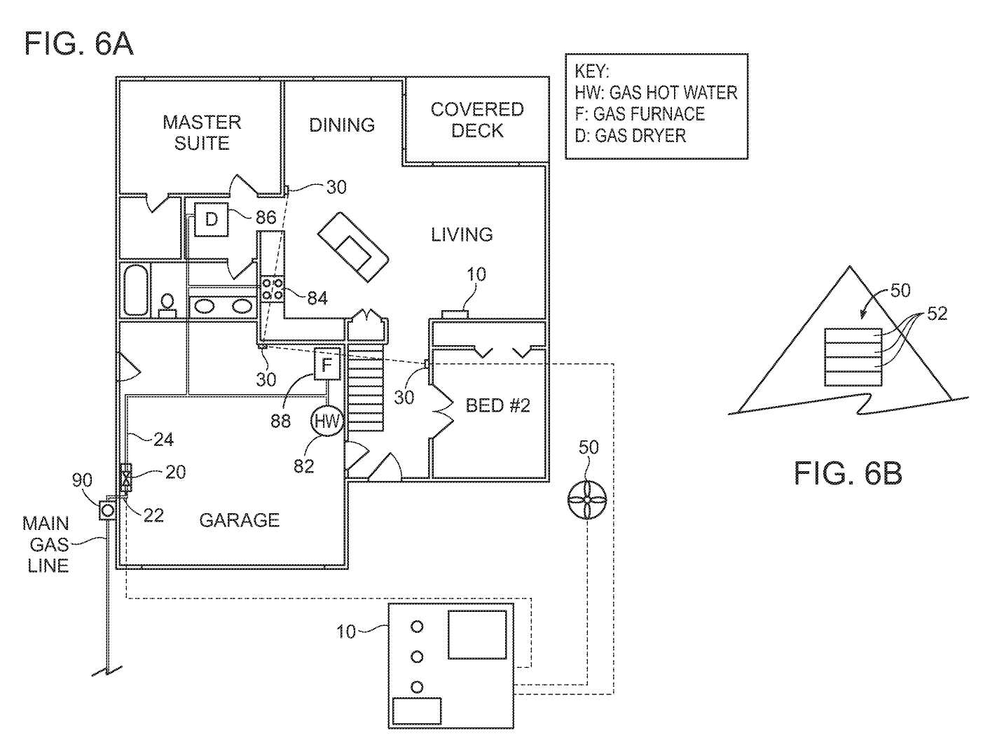

Valve 20 may be of the type that is compatible with natural gas or propane. In use, a gas (e.g., natural gas or propane) input line 22 is connected to the input 27 of the gas shutoff valve 20. The gas supply may be from a municipal natural gas supply or from the propane gas supply 72 of an RV 70 or other vehicle (see also FIGS. 5 and 6). As shown in the figures, a gas output line 24 is connected to the output 29 of the gas shutoff valve 20, and in turn, the output line 24 may be connected to one or more downstream gas appliances 80, as shown, for example, in FIGS. 5 and 6.

Other valve types are also available and would be usable with this system. For example, spring-loaded valves that trip upon application of a brief electrical current could be used, in addition to the types discussed above.

### E. Operation of Preferred Embodiment.

As shown in the figures, there are a few typical embodiments of the system, although in each case, the basic operation is the same. As one example, the system may be permanently installed in a home or apartment, where the system components are located relatively far away from each other, as best shown in FIG. 6A. Such a deluxe installation will normally be performed by a licensed or certified professional installer. As shown in FIG. 6B, the system may include a ventilation fan 50 behind a set of protective louvers 52, to more quickly clear the air within a living space of harmful substances such as carbon monoxide or smoke. Like the gas shutoff valve 20, the ventilation fan 50 may be operated automatically by the control unit 10, specifically, the fan 50 will be activated to run when an environmentally unsafe condition is sensed by any of the detectors 30 or 40, or any combination of them.

In this configuration, there may be a number of carbon monoxide detectors 30, and they may be located remotely from the control unit 10 and the gas shutoff valve 20. Typical of this configuration, the control unit 10 would be located in a convenient, central place, such as near an alarm control panel, HVAC return duct, or a main entry. Also typical of this configuration, the gas shutoff valve 20 may be located where the gas supply enters the house through gas inlet line 22, so that when it is activated, every gas-operated appliance (connected to gas outlet line 24) is cut off. As also shown, the shutoff valve 20 is typically downstream of the household's gas meter 90, connected to it by inlet line 22.

In this respect, natural gas flow to any malfunctioning appliance that may be producing dangerous levels of carbon monoxide in a structure or vehicle is terminated. As shown in FIG. 6A, such appliances may include a water heater 82, stove 84, gas dryer 86, and furnace 88, although these examples are not limiting.

The system may also be used of course to cut off gas flow if smoke is detected by a smoke detector 40, so that either smoke or carbon monoxide activates the system, which is true of other embodiments as well. This embodiment may include permanent, behind-the-wall wiring to the components of the system, such as those shown in FIGS. 2 and 6. The control unit may be powered by 110 VAC directly, or by an adapter, like those used for computers, which converts 110 VAC to a DC voltage (typically, 9 VDC) which in turn powers the control unit 10, and may also be used to active gas shutoff valve 20. As also shown in FIG. 2, this configuration, as well as others, may have a battery backup that can supply power to the entire system in the event of a power failure.

This configuration generally comprises one or more carbon monoxide detectors 30, each having an output, wherein the output is activated when a detected carbon monoxide level exceeds a threshold. Typically, the carbon monoxide detectors 30 will be recessed in the wall at 18″ AFF (above finished floor).

As discussed previously, the threshold may be a time-weighted threshold. Examples are: a threshold of no greater than 10 hours at a carbon monoxide level of 40 PPM; no greater than 50 minutes at a carbon monoxide level of 150 PPM, and no greater than 15 minutes at a carbon monoxide level of 400 PPM. Carbon monoxide detectors having their own logic to perform time-weighted triggering as discussed herein are specifically denoted by 30″, although carbon monoxide detectors generally are referred to as carbon monoxide detector 30, which may be any suitable type of detector as described herein.

The front of the control unit 10 will have the following features:
Power Indicator Light 16
9 VDC Battery (should be changed every season)
Low Battery Indicator (may be indicated by flashing power indicator)
Test Button 14
Display 18

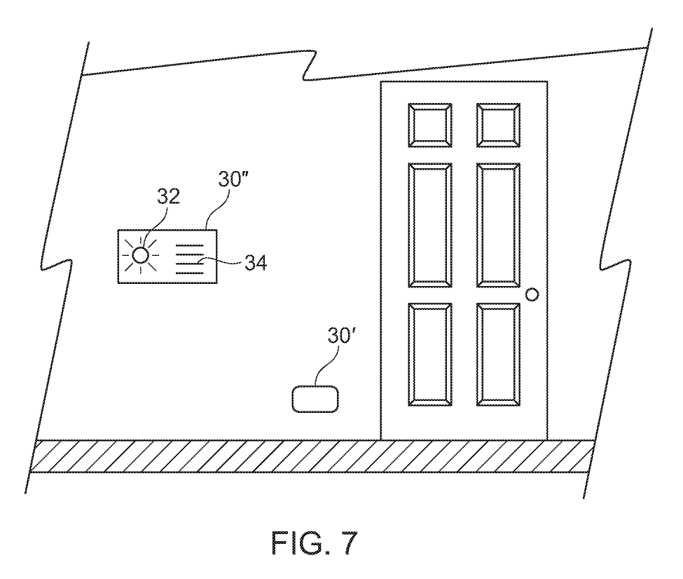

As also mentioned above, one or more carbon monoxide detectors 30′ may also be a sensor or detector without its own logic, in which case the control unit 10 may provide logic for determining the time-weighting. This type of sensor is generally denoted as 30′ in the figures, for example, in FIG. 7. Although specific values have been mentioned herein, other time-weighted values are possible. When the control unit 10 has internal logic and receives a signal or signals that are proportional to, or functions of, the detected carbon monoxide or gas level, the control unit 10 may provide a more detailed audible or visual indication of the conditions. The following are non-limiting examples, noting that the “ALARM” indicator 12 on the control unit's front panel may be a two-color LED capable of either flashing or continuous display of red or yellow light, and may have an internal audible alarm or transducer:
>50 ppm—Single beep every 30 seconds;
>75 ppm—Three simultaneous beeps every 30 seconds; flashing yellow LED;
>100 ppm—Continuous beep, continuous red LED illuminates, and outputs change state to close the gas shutoff valve and activate a ventilation fan (optional) and shut off a generator (RV option).

As the carbon monoxide levels decrease, the following actions will occur:
<100 ppm—Continuous beep stops, and starts beeping every 30 seconds. Red LED turns yellow and digital outputs return to normal state;
<75 ppm—Yellow LED is disabled;
<50 ppm—Single 30 second beep is disabled.

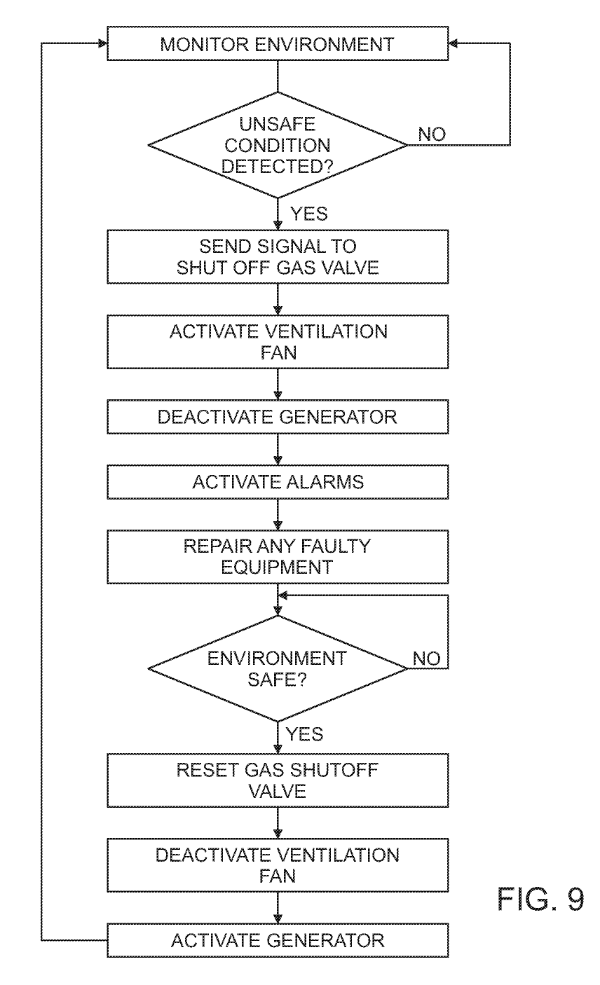

The basic sequence of system operation is shown in the flow chart of FIG. 9. In operation, the detectors 30 and 40 monitor or are exposed to carbon monoxide or smoke (or both) in an environment, such as a room. If the environmental state of air in the room is unsafe, one or both of the detectors have an output that will change state, such as a voltage that goes from a low value to a high value, such as 5 or 9 VDC. Alternatively, the detector, such as carbon monoxide detector 30, may simply provide an analog or digital signal that is proportional to, or a function of, the carbon monoxide level in the environment. In this embodiment, the monitoring function is shared by the control unit 10, which may calculate a time-weighted threshold as noted above, that ensures a safe condition, or trips the system and shuts off the gas shutoff valve 20 when the time-weighted threshold is exceeded.

If the environment in the monitored room or rooms becomes unsafe, the control unit 10 will send a signal, such as a voltage, to one or more devices or systems in response. For example, the control unit 10 may send a current or supply a voltage to the gas shutoff valve 20. The control unit 10 may also provide a visual and audible indication of the unsafe condition, as noted above with respect to various carbon monoxide levels. Such alarms and indications may be built in to the control unit 10, or may be external to it. The control unit 10 may also activate or deactivate other devices, such a ventilation fan 50, which will typically be activated, and a generator 60, which will typically be deactivated, when the system is “tripped” due to an unsafe environmental state. The control unit 10 may also send a signal to an outside entity, such as an alarm monitoring company, via interface 15, which may also include an autodialer with a cellular or landline telephone connection to an alarm company, fire department, etc.

Once the system is tripped, the gas shutoff valve 20 may remain off until further action is taken, such as a user performing a manual reset of the valve 20 by pushing plunger 26, or by the control unit 10 removing a voltage or current to the valve 20, either due to automatic action (such as detection of safe levels of smoke or carbon monoxide) or by a user performing an action at the control unit 10, such as pressing a reset button, etc. Such a manual action helps ensure that the triggering condition is remediated before the gas shutoff valve 20 is turned back on. Once a hazardous condition is cleared, the system may resume continuous monitoring of the room or environment, as before. Also, once the environment becomes safe again, normal operation of any equipment controlled by the control unit 10, such as ventilation fan 50 and generator 60, can resume.

The control unit 10 may also have a test function, wherein the control unit 10 sends an electrical output to close the gas shutoff valve 20 when the test function is activated. The test function may be activated manually by pressing the test button 14 on the front panel of the control unit 10, although other means of activation are possible. Pressing the test button will cause the system to respond as it would under actual alarm conditions, with the exception of initiating communication to an alarm company. Specifically, the test function will activate a built-in audible alarm, and change the state of any protective outputs, such as the gas valve output, ventilator fan output, and the generator interlock (if applicable). Activating the test function will also cause the control unit 10 to log the test and store it in memory. Such a log, as well as actual alarm events, may be downloaded onto a USB drive via USB port 17, or may be communicated to a user by other means, such as Wi-Fi or Bluetooth connection. As discussed above, such logs may be useful to insurance companies or other entities.

In a second possible configuration, the system may be used to protect the occupants of an RV 70 or other vehicle. In this application, the components would likely be installed at a factory at the time the RV is made, although it is certainly possible for it to be installed after manufacture, such as by a dealer. As shown in FIG. 3, the system may use a single carbon monoxide detector 30, in communication with a control unit 10, although it is also possible to use additional sensors such as smoke detectors 40. In this application, the gas shutoff valve 20 will also be located near the propane supply 72 of the RV 70, so that the gas supply to any gas appliance 80 (not shown) that is malfunctioning and producing dangerous levels of carbon monoxide will be terminated. As with a household application, an RV 70 may also include a ventilation fan 50 to help clear an unsafe environmental condition within the RV if carbon monoxide or smoke is detected.

Other than the power supply used and the number and types of detectors, many of the features described above regarding the more permanent “home” configuration would be applicable to this configuration. For example, the indicated alarm conditions and set points would be the same, as would the valve operation, although a different valve voltage is likely. For example, the valve of the RV application may operate at 12 VDC or 24 VDC, rather than, for example, 24 VAC or 110 VAC which may be used in the residential application discussed above.

The carbon monoxide detector 30 in this configuration may be either recessed or mounted to the face of a wall at 18″ AFF at a predetermined location or at the toe kick level in the RV 70 in a general location. These options are shown generally in FIG. 7. If a flush-mounted detector 30″ is used, it may include a power indicating flashing light 32, as well as its own audible alarm 34. As shown in FIG. 7, a simple sensor 30′ (e.g., a sensor with less logic and processing than type 30″) may also be used, and may conveniently be mounted lower, near the toe kick of the RV's interior.

In the RV configuration, the generator interlock output of the control unit 10 may also be used. This output may be in the form of a normally closed relay contact that opens upon an alarm condition. Opening the contact may stop operation of an electrical generator 60 used to provide electrical power to the RV, and thus, stopping the generator 60 may provide additional security in the event of a dangerous level of carbon monoxide or smoke within the RV or other space.

The front of the control unit 10 may have the following features:
Power Indicator Light 16
9 VDC Battery (should be changed every season)
Low Battery Indicator (may be indicated by flashing power indicator)
Test Button 14
Display 18

In another possible configuration, the system may be installed more locally—i.e., near a gas appliance 80. Rather than the more professionally installed deluxe residential application described above, this configuration may be more readily installed by a homeowner—for example, after a house is built. As with the previous two systems, however, the overall operation, sensors, and controls is the same or similar.

In this embodiment, rather than using more remote carbon monoxide detectors and a single, source-located gas shutoff valve that will cut off the supply of gas to all appliances, this configuration may use a carbon monoxide detector 30, control unit 10, and a gas shutoff valve 20 mounted very close to an appliance 80 that may use propane or natural gas, such as a water heater 82. This basic setup is illustrated in FIG. 5. Due to its size, limited number of components, and ease of installation, it is envisioned that in this embodiment or configuration of the system, a different control unit 10, detector 30, and gas shutoff valve 20 would be used for, and located near, any appliance to be protected.

The front of the control unit 10 in this configuration will have the following features:
Power Indicator Light 16
9 VDC Battery (should be changed every season)
Low Battery Indicator (may be indicated by flashing power indicator)
Test Button 14
Display 18

One feature of this configuration is the location of the gas shutoff valve 20, which is at the point of connection of an appliance. This not only allows for easier installation of the system by a homeowner, but provides the ability to isolate the incoming gas at the point of connection. For example, for a furnace 88 in a garage and a water heater 82 in a basement, an installer would install two systems, with two gas shutoff valves 20, near each appliance. Such an installation is shown in FIG. 5, where the gas shutoff valve 20 is installed between a gas inlet line 22 and outlet line 24 to directly and locally control the gas supply to a water heater 82, using a control unit 10 and carbon monoxide detector 30 located near the water heater 82.

In any of the configurations described above, the output of the control unit 10 to the gas shutoff valve 20 may take several forms. For example, the output may be a fixed duration voltage output that is sufficient to close the valve 20, but, since, in one embodiment the valve 20 has a manual reset function and normally remains closed, the voltage output may return to a neutral state after a fixed time. Alternatively, the output may be a latched output that remains in the active state until the environment has returned to a safe level and the valve 20 has been reset to the open state by the user.

Unless otherwise defined, all technical and scientific terms used herein have the same meaning as commonly understood by one of ordinary skill in the art to which this invention belongs. Although methods and materials similar to or equivalent to those described herein can be used in the practice or testing of the automatic gas shutoff system, suitable methods and materials are described above. All publications, patent applications, patents, and other references mentioned herein are incorporated by reference in their entirety to the extent allowed by applicable law and regulations. The automatic gas shutoff system may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

What is claimed is:

1. An automatic gas shutoff system, comprising:
a gas shutoff valve having an inlet port and an outlet port, wherein the inlet port is fluidly connected to a gas inlet line, wherein the outlet port is fluidly connected to a gas outlet line, wherein the gas inlet line is fluidly connected to a gas source and wherein the gas outlet line is connectable to a gas appliance, wherein the gas shutoff valve has an open state that allows passage of gas and a closed state that prevents passage of gas, wherein the gas shutoff valve is normally in the open state;
a first detector having an output, wherein the first detector is adapted to detect an environmental state of air in a room, and wherein the first detector is adapted to transmit an environmental state data based on the environmental state of air in the room; and
a control unit in communication with the first detector to receive the environmental state data from the output of the first detector, wherein the control unit is in communication with the gas shutoff valve to control whether the gas shutoff valve is in the open state or closed state, wherein the control unit transmits a close signal to cause the gas shutoff valve to change from the open state to the closed state when the environmental state of the air in the room is determined to be in an unsafe state.

2. The automatic gas shutoff system of claim 1, wherein the first detector is a smoke detector.

3. The automatic gas shutoff system of claim 1, wherein the first detector is a carbon monoxide detector.

4. The automatic gas shutoff system of claim 3, wherein the output of the first detector is a function of a carbon monoxide level in the room.

5. The automatic gas shutoff system of claim 4, further comprising a second detector, wherein the second detector comprises a carbon monoxide detector, the second detector having an output, wherein the second detector is adapted to detect an environmental state of air in a room, and wherein the second detector is adapted to transmit a second environmental state data based on the environmental state of air in the room.

6. The automatic gas shutoff system of claim 4, further comprising a second detector, wherein the second detector comprises a smoke detector, the second detector having an output, wherein the second detector is adapted to detect an environmental state of air in a room, and wherein the second detector is adapted to transmit a second environmental state data based on the environmental state of air in the room.

7. The automatic gas shutoff system of claim 4, wherein the environmental state of the air in the room is determined to be in an unsafe state when a time-weighted threshold of carbon monoxide is exceeded.

8. The automatic gas shutoff system of claim 1, wherein the environmental state of the air in the room is determined to be in an unsafe state when a time-weighted threshold of carbon monoxide is exceeded.

9. The automatic gas shutoff system of claim 1, wherein the gas shutoff valve comprises a manual reset.

10. The automatic gas shutoff system of claim 9, wherein the gas shutoff valve remains closed without a signal until it is manually reset.

11. The automatic gas shutoff system of claim 10, wherein the close signal of the control unit has a fixed duration.

12. The automatic gas shutoff system of claim 1, wherein the close signal of the control unit remains in a steady state once it is activated.

13. The automatic gas shutoff system of claim 1, wherein the control unit comprises an audible alarm that sounds when the environmental state of the air in the room is determined to be in an unsafe state.

14. The automatic gas shutoff system of claim 1, wherein the control unit further comprises an interface to a remote alarm company, and wherein the control unit sends an alarm signal to the alarm company when the environmental state of the air in the room is determined to be in an unsafe state.

15. The automatic gas shutoff system of claim 1, wherein the control unit further comprises a test function, wherein the control unit transmits a close signal to cause the gas shutoff valve to change from the open state to the closed state when the test function is activated.

16. The automatic gas shutoff system of claim 15, wherein the control unit further comprises an onboard storage, and wherein the control unit stores test information in the onboard storage when the test function is activated.

17. An automatic gas shutoff system, comprising:
a gas shutoff valve having an inlet port and an outlet port, wherein the inlet port is fluidly connected to a gas inlet line, wherein the outlet port is fluidly connected to a gas outlet line, wherein the gas inlet line is fluidly connected to a gas source and wherein the gas outlet line is connectable to a gas appliance, wherein the gas shutoff valve has an open state that allows passage of gas and a closed state that prevents passage of gas;
wherein the gas shutoff valve is normally in the open state and wherein the gas shutoff valve comprises a manual reset;
wherein the gas shutoff valve remains closed without a signal until it is manually reset;
a first carbon monoxide detector having an output, wherein the first carbon monoxide detector is adapted to detect an environmental state of air in a room, and wherein the first carbon monoxide detector is adapted to transmit an environmental state data based on the environmental state of air in the room;
a second carbon monoxide detector having an output, wherein the second carbon monoxide detector is adapted to detect an environmental state of air in the room, and wherein the second detector is adapted to transmit a second environmental state data based on the environmental state of air in the room;
a smoke detector, the smoke detector having an output, wherein the smoke detector is adapted to detect an environmental state of air in the room, and wherein the smoke detector is adapted to transmit a third environmental state data based on the environmental state of air in the room; and
a control unit in communication with the first detector to receive the environmental state data from the output of the first detector, wherein the control unit is in communication with the gas shutoff valve to control whether the gas shutoff valve is in the open state or closed state, wherein the control unit transmits a close signal to cause the gas shutoff valve to change from the open state to the closed state when the environmental state of the air in the room is determined to be in an unsafe state.

18. The automatic gas shutoff system of claim 17, wherein the close signal of the control unit has a fixed duration.

19. The automatic gas shutoff system of claim 17, wherein the close signal of the control unit remains in a steady state once it is activated.

20. The automatic gas shutoff system of claim 17, wherein the control unit comprises an audible alarm that sounds when the environmental state of the air in the room is determined to be in an unsafe state.
